(19) United States
(12) Patent Application Publication
(10) Pub. No.: US 2013/0262977 A1
(43) Pub. Date: Oct. 3, 2013

(54) Controlling Browser Preferences with a Rich Internet Application

(71) Applicants: Ian Tewksbury, Morrisville, NC (US); Jianjun Zhang, Cary, NC (US)

(72) Inventors: Ian Tewksbury, Morrisville, NC (US); Jianjun Zhang, Cary, NC (US)

(73) Assignee: INTERNATIONAL BUSINESS MACHINES CORPORATION, Armonk, NY (US)

(21) Appl. No.: 13/436,245

(22) Filed: Mar. 30, 2012

(51) Int. Cl. G06F 17/00

(52) U.S. Cl. 715/234

(57) ABSTRACT

Methods and systems may involve transferring application information from a rich Internet application (RIA) to a browser extension via a common protocol node, and using the browser extension to change a browser preference in accordance with the application information. In one example, the common protocol node is a document object model (DOM) node that is common to all Internet applications using a communication protocol associated with the DOM node.

### BACKGROUND

Embodiments of the present invention generally relate to the management of browser preferences. More particularly, embodiments relate to the management of browser preferences through rich Internet applications.

A rich Internet application (RIA) may use technology such as, for example, Adobe Flash or JavaScript technology, to provide enhanced functionality in web browsing environments. The ability to change certain browser preferences, however, may be challenging in the RIA context. For example, browser preferences such as the user-agent identifier (ID) can be used to inform web servers of the type of browser that is requesting web content, but the user-agent ID is traditionally only accessible by a browser extension. Thus, in order to change the user-agent ID, an RIA user may be required to exit the RIA, and make the change from within the user interface of the browser extension. Such an approach can be time consuming and inconvenient, and may lead to a sub-optimal user experience.

### BRIEF SUMMARY

Embodiments may include a computer program product having a computer readable storage medium and computer usable code stored on the computer readable storage medium. If executed by a processor, the computer usable code may cause a computer to transfer application information from a rich Internet application (RIA) to a browser extension via a common protocol node. In addition, the computer usable code can cause a computer to use the browser extension to change a browser preference in accordance with the application information.

Embodiments may also include a computer implemented method in which a unique identifier (ID) is determined for a document object model (DOM) node, wherein the DOM node is common to all Internet applications using a communication protocol associated with the DOM node. In addition, the method may provide for transferring application information from an RIA to a browser extension via the DOM node, wherein transferring the application information includes setting an attribute-value pair on the DOM node based on the application information and using the DOM node to generate an event notification. The method can also involve detecting the event notification in the browser extension, using the browser extension to read the attribute-value pair in response to the event notification, and using the browser extension to change a browser preference in accordance with the application information. The browser preference may include, but is not limited to, one or more of a user-agent ID and a language setting.

Embodiments may also include a computer program product having a computer readable storage medium and computer usable code stored on the computer readable storage medium. If executed by a processor, the computer usable code may cause a computer to determine a unique ID for a DOM node, wherein the DOM node is common to all Internet applications using a communication protocol associated with the DOM node. The instructions can also cause a computer to transfer application information from an RIA to a browser extension via the DOM node, wherein transferring the application is to include setting an attribute-value pair on the DOM node based on the application information and using the DOM node to generate an event notification. Additionally, the instructions may cause a computer to detect the event notification in the browser extension, use the browser extension to read the attribute-value pair in response to the event notification, and use the browser extension to change a browser preference in accordance with the application information. The browser preference may include, but is not limited to, one or more of a user-agent ID and a language setting.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is a block diagram of an example of an RIA having a user interface configured to change browser settings according to an embodiment;

FIG. 2 is a block diagram of an example of an RIA having multiple browser simulators configured to change browser settings according to an embodiment;

FIG. 3 is a flowchart of an example of a method of using a common protocol node to communicate between an RIA and a browser extension; and

FIG. 4 is a block diagram of an example of a networking architecture according to an embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

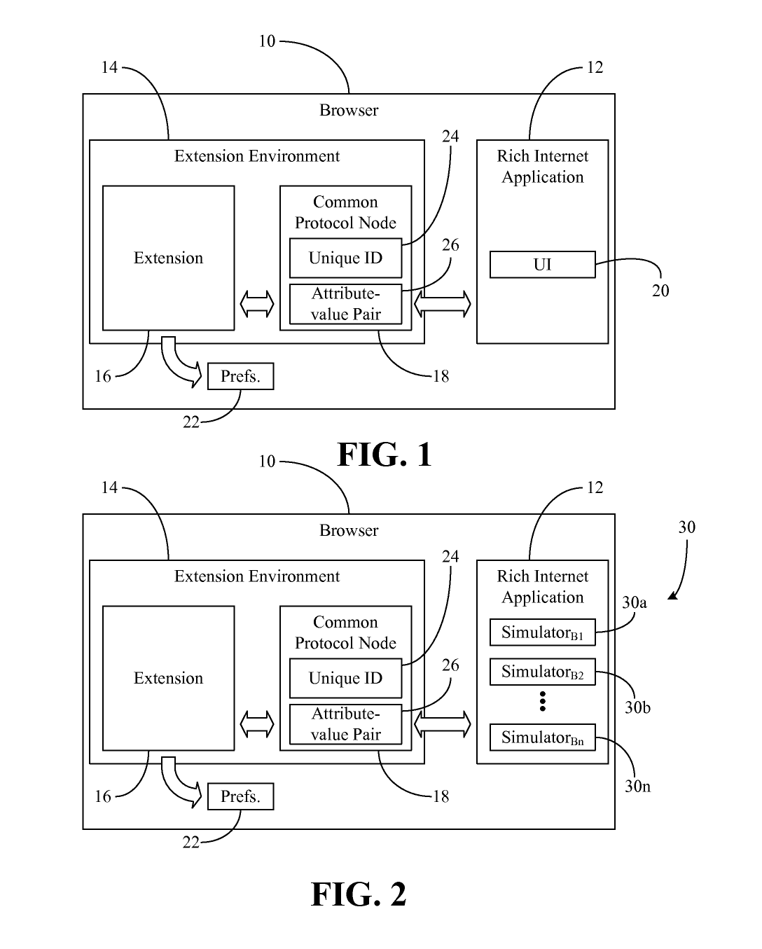

Referring now to FIG. 1, a browser 10 that includes a rich Internet application (RIA) 12 and an extension environment 14, is shown. Example browsers include, but are not limited to, Firefox and/or Firefox Mobile from Mozilla, Internet Explorer and/or Internet Explorer for Mobile from Microsoft, other device-specific proprietary browsers (e.g., Apple iPhone web browser), etc. The RIA 12 may include application technology such as, for example, Flash or JavaScript technology, that enables a user of the browser 10 to experience a more robust set of features and/or functionality while interacting with the browser 10. In the illustrated example, the RIA 12 includes a user interface (UI) 20 configured to facilitate such interaction between the RIA 12 and the user. Accordingly, the UI 20 may receive user input, wherein the user input can indicate a desire to change one or more browser preferences 22 such as, for example, language settings and user-agent IDs. As will be discussed in greater detail, the user input may be considered application information that can be passed to the extension environment 14 without requiring the user to interact directly with the extension environment 14.

In particular, the illustrated extension environment 14 has a browser plug-in/extension 16 and a common protocol node 18, wherein the browser extension 16 is able to change the browser preferences 22 in accordance with the application information obtained from the RIA 12. Moreover, the common protocol node 18 may be configured to enable the transfer of such information between the RIA 12 and the browser extension 16. Because the illustrated RIA 12 need only be aware of the common protocol node 24 and the underlying protocol of transferring application information through the node 24 (e.g., the associated communication protocol), the RIA 12 may be configured to be browser “agnostic” while still being able to change the preferences 22 of the browser 10.

In one example, the common protocol node 18 is a document object model (DOM) node that is common to all Internet applications using the communications protocol associated with the DOM node. Accordingly, the common protocol node 18 may have a unique ID 24 and an attribute-value pair 26, wherein both the RIA 12 and the browser extension 16 are aware of the unique ID 24 and may set the attribute-value pair 26 in order to pass information between the RIA 12 and the browser extension 16. Thus, in the case of the RIA 12 making a change to the browser preferences 22, the illustrated RIA 12 would simply write the desired application information to the attribute-value pair 26 of the node 24 and generate a JavaScript event notification using the DOM node as the parent for the event, wherein the event notification may inform the browser extension 16 that the attribute-value pair 18 has changed. The browser extension 16 can detect the event notification, read the application information from the attribute-value pair 26 in response to the event notification, and change the browser preferences 22 in accordance with the application information obtained from the common protocol node 18. In addition, other information, such as set-up information and preference change confirmations, may be exchanged between the RIA 28 and the browser extension 16 via the common protocol node 18. While other types of common protocol nodes may be used, DOM nodes may be relatively straightforward to implement and can be easy to debug.

FIG. 2 shows the browser 10 in a scenario in which an RIA 28 emulates multiple browsers in the same browser window. In particular, the illustrated RIA 28 has multiple browser simulators 30 (30a-30n), wherein each simulator 30 may correspond to a different type of browser. For example, a first simulator (“Simulator_{B1}”) 30a might emulate an Internet Explorer for Mobile browser, whereas a second simulator (“Simulator_{B2}”) may emulate a Firefox Mobile browser. Accordingly, web requests from each of the two browser simulators 30a and 30b may incorporate a user-agent ID corresponding to the type of browser in question. In order to ensure that the correct user-agent ID is incorporated into the web requests, the browser extension 16 may operate in the background and effectively intercept the web request events originating from the RIA 28, and defer the intercepted web requests until the user-agent ID has been changed to the correct value. More particularly, the browser simulators 30 of the RIA 28 may be configured to modify the attribute-value pair 18 of the common protocol node 18 with each web request and generate a corresponding event notification, wherein the browser extension 16 may detect the event notification, defer the web request, change the user-agent ID, and permit the web request to proceed once the user-agent ID change has been made.

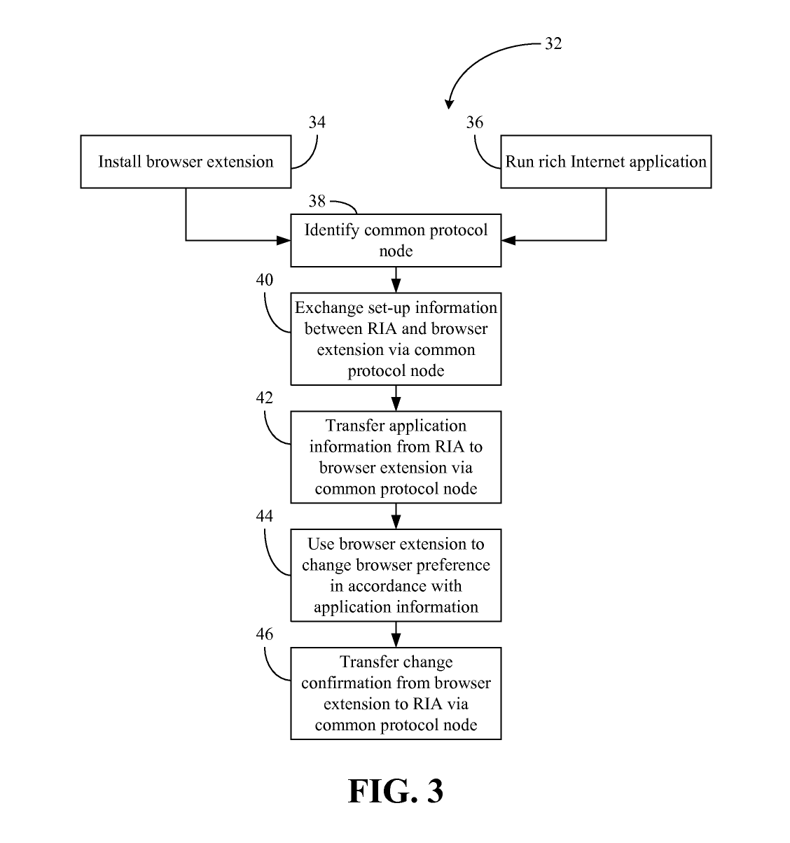

Turning now to FIG. 3, a method 32 of using a common protocol node to communicate between an RIA and a browser extension is shown. In the illustrated example, processing block 34 provides for installing a browser extension, wherein the browser extension installation process may involve obtaining user authorization. In addition, an RIA may be run/invoked at block 36. Illustrated block 38 identifies a common protocol node such as a DOM node that is common to all Internet applications in the system using the DOM application programming interface (API). Set-up “handshake” information may be exchanged between the RIA and the browser extension at block 40 via the common protocol node, wherein the set-up information may include, for example, information regarding the unique ID of the common protocol node, version information, and so forth. With specific regard to the exchange of version information, when an RIA and a browser extension begin to communicate with one another, they may discover that they are configured at different versions of the same communication protocol. In such a case, the set-up process might involve modifying the function set of the browser extension and/or RIA so that the two components are compatible with one another.

Illustrated block 42 provides for transferring application information from the RIA to the browser extension via the common protocol node. The transfer may be in response to user input obtained from a UI such as the UI 20 (FIG. 1), in conjunction with an “intercepted” web request from a browser simulator such as the simulators 30 (FIG. 2), or any combination thereof. The browser extension may be used to change one or more browser preferences at block 44 in accordance with the application information, wherein block 46 may transfer a change confirmation from the browser extension to the RIA to notify the RIA that the browser preference change is complete.

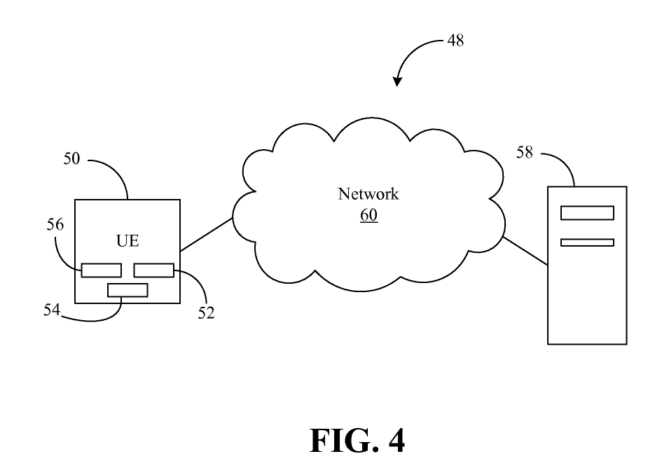

FIG. 4 shows a networking architecture 48 in which a user equipment (UE) device 50 includes a browser extension 52 and an RIA 54 that communicate with one another via a common protocol node 56, as already discussed. In the illustrated example, a server 58 is configured to provide web content to the UE device 50 via a network 60. The network 60 can itself include any suitable combination of servers, access points, routers, base stations, mobile switching centers, public switching telephone network (PSTN) components, etc., to facilitate communication between the UE device 50 and the servers 58. In one example, the server 58 responds to web requests from multiple browser simulators of the RIA 54 running in the same browser window, wherein the browser extension 52 is configured to automatically defer each web request while the browser extension changes the user-agent ID to match the browser simulator originating the web request. Accordingly, the illustrated web server 58 can configure the transmitted web content for the browser simulator in question.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computer-implemented method comprising:
determining a unique identifier for a document object model (DOM) node, wherein the DOM node is common to all Internet applications using a communication protocol associated with the DOM node;
transferring application information from a rich Internet application to a browser extension via the DOM node, wherein transferring the application information includes setting an attribute-value pair on the DOM node based on the application information and using the DOM node to generate an event notification;
detecting the event notification in the browser extension;
using the browser extension to read the attribute-value pair in response to the event notification; and
using the browser extension to change a browser preference in accordance with the application information, wherein the browser preference includes one or more of a user-agent identifier and a language setting.

2. The method of claim 1, further including receiving the application information at the rich Internet application from a user interface.

3. The method of claim 1, further including deferring one or more web requests until the browser preference has been changed.

4. The method of claim 1, further including transferring a change confirmation from the browser extension to the rich Internet application via the DOM node.

5. The method of claim 1, further including exchanging set-up information between the rich Internet application and the browser extension via the DOM node.

6. A computer program product comprising:
a computer readable storage medium; and
computer usable code stored on the computer readable storage medium, wherein if executed by a processor, the computer usable code causes a computer to:
determine a unique identifier for a document object model (DOM) node, wherein the DOM node is common to all Internet applications using a communication protocol associated with the DOM node;
transfer application information from a rich Internet application to a browser extension via the DOM node, wherein transferring the application is to include setting an attribute-value pair on the DOM node based on the application information and using the DOM node to generate an event notification;
detect the event notification in the browser extension;
use the browser extension to read the attribute-value pair in response to the event notification; and
use the browser extension to change a browser preference in accordance with the application information, wherein the browser preference is to include one or more of a user-agent identifier and a language setting.

7. The computer program product of claim 6, wherein the computer usable code, if executed, causes a computer to receive the application at the rich Internet application from a user interface.

8. The computer program product of claim 6, wherein the computer usable code, if executed, causes a computer to defer one or more web requests until the browser preference has been changed.

9. The computer program product of claim 6, wherein the computer usable code, if executed, causes a computer to transfer a change confirmation from the browser extension to the rich Internet application via the DOM node.

10. The computer program product of claim 6, wherein the computer usable code, if executed, causes a computer to exchange set-up information between the rich Internet application and the browser extension via the DOM node.

11. A computer program product comprising:
a computer readable storage medium; and
computer usable code stored on the computer readable storage medium, wherein if executed by a processor, the computer usable code causes a computer to:
transfer application information from a rich Internet application to a browser extension via a common protocol node; and
use the browser extension to change a browser preference in accordance with the application information.

12. The computer program product of claim 11, wherein the computer usable code, if executed, causes a computer to:
set an attribute-value pair on the common protocol node based on the application information;
use the common protocol node to generate an event notification;
detect the event notification in the browser extension; and
use the browser extension to read the attribute-value pair in response to the event notification.

13. The computer program product of claim 11, wherein the computer usable code, if executed, causes a computer to determine a unique identifier for the common protocol node.

14. The computer program product of claim 11, wherein the common protocol node is to be common to all Internet applications using a communication protocol associated with the common protocol node.

15. The computer program product of claim 11, wherein the common protocol node is to be a document object model (DOM) node.

16. The computer program product of claim 11, wherein the computer usable code, if executed, causes a computer to receive the application information at the rich Internet application from a user interface.

17. The computer program product of claim 11, wherein the browser preference is to include one or more of a user-agent identifier and a language setting.

18. The computer program product of claim 11, wherein the computer usable code is to defer one or more web requests until the browser preference has been changed.

19. The computer program product of claim 11, wherein the computer usable code is to transfer a change confirmation from the browser extension to the rich Internet application via the common protocol node.

20. The computer program product of claim 11, wherein the computer usable code is to exchange set-up information between the rich Internet application and the browser extension via the common protocol node.
